(19) United States
(12) Patent Application Publication
(10) Pub. No.: US 2025/0344669 A1
(43) Pub. Date: Nov. 13, 2025

(54) NOVEL CAT CAGE

(71) Applicant: Jiahong SU, Guangdong Province (CN)

(72) Inventor: Jiahong SU, Guangdong Province (CN)

(21) Appl. No.: 18/657,799

(22) Filed: May 8, 2024

(51) Int. Cl. A01K 1/03; A01K 1/01; A01K 1/035

(52) U.S. Cl. CPC A01K 1/033; A01K 1/0107

(57) ABSTRACT

A cat cage, having a cage body; a right portion of the cage body is a playing area, a left portion in the cage body is a toilet, a dining area is provided at a right side of the toilet, a sleeping area is provided on top of the toilet and the dining area, an access opening is provided at a front portion of one side of the toilet, a litter box is configured to be placed in the toilet, a food bowl and a water bowl are configured to be placed in the dining area, a lower cage door is provided in front of the toilet, and an upper cage door is provided in front of the playing area. The toilet is a substantially closed and independent area, the dining area is a semi-closed area, and the sleeping area is on an upper deck of the cat cage.

### BACKGROUND OF THE INVENTION

The present invention relates to the technical field of cat cages, and in particular to a novel cat cage.

A cat cage is a kind of pet cage comprising a cage body and a cage door so as to provide an independent activity and play area for a cat where the cat can live in and play. Cat cage is commonly used in the pet industry. However, most of the existing cat cages are single-deck with poor space utilization, where a litter box may be placed together with the food and water, or the food and water may be placed in the cat playing area. This may hinder the cat from playing, or the food and water may be messed up. Therefore, existing cat cages are inconvenient for the cat to eat, excrete, rest, and play, thus resulting in poor user's experience. Therefore, there is a need for improvements to overcome the shortcomings in the field of art.

### BRIEF SUMMARY OF THE INVENTION

In view of the aforesaid disadvantages now present in the prior art, the present invention provides a novel cat cage which is structurally simple and convenient to use.

The technical scheme of the present invention is detailed as follows:

A cat cage, comprising a cage body; a playing area is provided in a right portion in the cage body, a toilet is provided in a left portion in the cage body, a dining area is provided at a right side of the toilet, a sleeping area is provided on top of the toilet and the dining area, an access opening is provided at a front portion of one side of the toilet, a litter box is configured to be placed in the toilet, a food bowl and a water bowl are configured to be placed in the dining area, a lower cage door is provided in front of the toilet, and an upper cage door is provided in front of the playing area.

Further, a separator board is provided between the toilet and the dining area.

Further, a right baffle is provided at a bottom portion of a right side of the toilet.

Further, a lower baffle is provided at a bottom portion of a right side of the dining area.

Further, an upper baffle is provided at a right side of the sleeping area.

Further, a front protective net is provided at a front side of the cage body.

Further, a right protective net is provided at a right side of the cage body.

Further, an upper protective net is provided on a top side of the cage body.

Further, the cage body is formed by wood material and meshes.

Further, casters with brakes are provided at a bottom side of the cage body.

According to the present invention, the playing area is provided in the right portion in the cage body, the toilet is provided in the left portion in the cage body, the dining area is provided at the right side of the toilet, the sleeping area is provided on the top of the toilet and the dining area, the access opening is provided at the front portion of one side of the toilet, the lower cage door is provided in front of the toilet, and the upper cage door is provided in front of the playing area, accordingly, the cat cage has a simple structure with a partitioned design and a double-deck design, thereby enhancing space utilization, facilitating the cat to eat, excrete, rest, and play, thus resulting in a good user's experience. The present invention achieves the following beneficial effects:

1. The toilet formed by a space defined by a bottom side of the sleeping area, sides of the cage body, and the separator board separating the toilet and the dining area, is substantially closed and independent, with only the access opening left at the front portion of one side of the toilet for the cat to come in and out of the toilet; a litter box is configured to be placed in the toilet, which can be cleaned conveniently by opening the lower cage door.

2. The dining area is semi-closed, and is separated from the toilet by the separator board; the dining area is configured to allow only one food bowl and one water bowl to fit in, so that the food bowl and the water bowl, when being fitted in the dining area, are firmly confined by the dining area such that the food and water will not be messed up easily.

3. The sleeping area is independently provided on an upper deck (on top of the toilet and the dining area).

4. The playing area is an independent space without any barrier at all, such that the cat can play freely and happily, and the owner can interact with the cat for fun by opening the upper cage door, making the novel cat cage suitable for keeping the cat indoor.

5. The structure of the cat cage is designed cleverly and reasonably, so that the problems in conventional cat cages are solved. According to the present invention, the litter box is not placed together with the food and water, or the food and water are not placed in the playing area, therefore, the cat will not be hindered from playing and the food and water may not be easily messed up.

### BRIEF DESCRIPTION OF THE DRAWINGS

In order to illustrate the technical solutions in the embodiments of the present invention or in the field of art more clearly, the following briefly introduces the accompanying drawings for describing the embodiments or the field of art. Apparently, the drawings in the following description show merely some but not all embodiments of the present invention, and a person of ordinary skills in the art may still derive other drawings based on the accompanying drawings given that no inventive effort is required.

FIG. 1 is a structural schematic diagram of a novel cat cage according to the present invention; and

FIG. 2 is a structural exploded view of the novel cat cage according to the present invention.

In the drawings: 1—cage body; 2—playing area; 3—toilet; 4—dining area; 5—sleeping area; 6—access opening; 7—lower cage door; 8—upper cage door; 9—separator board; 10—right baffle; 11—lower baffle; 12—upper baffle; 13—front protective net; 14—right protective net; 15—upper protective net; 16—caster.

### DETAILED DESCRIPTION OF THE INVENTION

The technical solution of the present invention will be clearly and thoroughly described with reference to the drawings of the embodiments of the present invention, where the described embodiments are obviously some, but not all, of the embodiments of the present invention. On the basis of the embodiments of the present invention, all other embodiments obtainable by those of ordinary skills in the art without any inventive effort shall fall within the protection scope of the present invention.

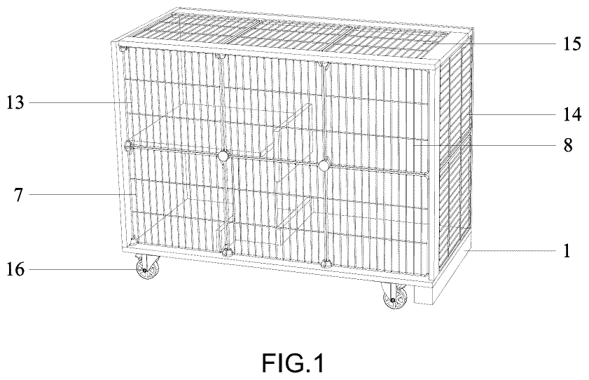

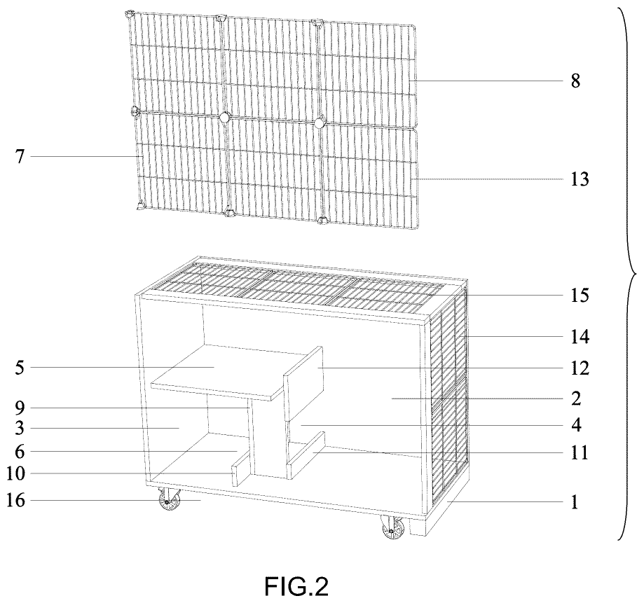

As shown in FIG. 1 and FIG. 2, a novel cat cage of the present invention comprises a cage body 1, where a playing area 2 is provided in a right portion in the cage body 1, a toilet 3 is provided in a left portion in the cage body 1, a dining area 4 is provided at a right side of the toilet 3, a sleeping area 5 is provided on top of the toilet 3 and the dining area 4, an access opening 6 is provided at a front portion of one side of the toilet 3, a litter box is configured to be placed in the toilet 3, a food bowl and a water bowl are configured to be placed in the dining area 4, a lower cage door 7 is provided in front of the toilet 3, and an upper cage door 8 is provided in front of the playing area 2. According to the present invention, the playing area 2 is provided in the right portion in the cage body 1, the toilet 3 is provided in the left portion in the cage body 1, the dining area 4 is provided at the right side of the toilet 3, the sleeping area 5 is provided on the top of the toilet 3 and the dining area 4, the access opening 6 is provided at the front portion of one side of the toilet 3, the lower cage door 7 is provided in front of the toilet 3, and the upper cage door 8 is provided in front of the playing area 2, accordingly, the cat cage has a simple structure with a partitioned design and a double-deck design, thereby enhancing space utilization, facilitating the cat to eat, excrete, rest, and play, thus resulting in a good user's experience. The present invention achieves the following beneficial effects:

1. The toilet 3 formed by a space defined by a bottom side of the sleeping area, sides of the cage body, and a separator board (which will be described in detail below) separating the toilet and the dining area, is substantially closed and independent, with only the access opening 6 left at the front portion of one side of the toilet 3 for the cat to come in and out of the toilet; a litter box is configured to be placed in the toilet 3, which can be cleaned conveniently by opening the lower cage door 7.

2. The dining area 4 is semi-closed, and is separated from the toilet by the separator board; the dining area 4 is configured to allow only one food bowl and one water bowl to fit in, so that the food bowl and the water bowl, when being fitted in the dining area, are firmly confined by the dining area 4 such that the food and water will not be messed up easily.

3. The sleeping area 5 is independently provided on an upper deck (on top of the toilet 3 and the dining area 4).

4. The playing area 2 is an independent space without any barrier at all, such that the cat can play freely and happily, and the owner can interact with the cat for fun by opening the upper cage door 8, making the novel cat cage suitable for keeping the cat indoor.

5. The structure of the cat cage is designed cleverly and reasonably, so that the problems in conventional cat cages are solved. According to the present invention, the litter box is not placed together with the food and water, or the food and water are not placed in the playing area, therefore, the cat will not be hindered from playing and the food and water may not be easily messed up.

A separator board 9 is provided between the toilet 3 and the dining area 4 to isolate the areas for excretion from the area for eating, such that the food and water may not be easily polluted.

A right baffle 10 is provided at a bottom portion of a right side of the toilet 3 to isolate the area for excretion from the area for playing, such that the cat may not be dirtied or hindered from playing.

A lower baffle 11 is provided at a bottom portion of a right side of the dining area 4 to isolate the area for eating from the area for playing, such that the food and water may not easily messed up.

An upper baffle 12 is provided at a right side of the sleeping area 5 to isolate the area for playing from the area for sleeping and resting, thereby improving safety and quality of sleep of the cat.

A front protective net 13 is provided at a front side of the cage body 1 so that air ventilation is possible at the front side of the cage body 1 and the activities of the cat can be observed through the front protective net 13.

A right protective net 14 is provided at a right side of the cage body 1 so that air ventilation is possible at the right side of the cage body 1 and the activities of the cat can be observed through the right protective net 14.

An upper protective net 15 is provided on a top side of the cage body 1 so that air ventilation is possible at the top side of the cage body 1 and the activities of the cat can be observed through the upper protective net 15.

The cage body 1 is formed by wood material and meshes, so that the cage body 1 is convenient to manufacture, stable in structure, and comfortable to use.

Casters 16 with brakes are provided at a bottom side of the cage body 1, so that the cat cage can be conveniently moved and stably placed.

In a specific implementation, a rear side of the cage body 1 may be formed as a wooden board or a protective net.

In a specific implementation, the toilet 3, the dining area 4, and the sleeping area 5 may be provided in the right portion in the cage body 1, and the playing area 2 may be provided in the left portion in the cage body 1.

The foregoing shows only preferred embodiments of the present invention and is not intended to limit the present invention. Any modification, alternative configurations, and improvements made within the essence and principle of the present invention shall fall within the protection scope of the present invention.

What is claimed is:

1. A cat cage, comprising a cage body; a playing area is provided in a right portion in the cage body, a toilet is provided in a left portion in the cage body, a dining area is provided at a right side of the toilet, a sleeping area is provided on top of the toilet and the dining area, an access opening is provided at a front portion of one side of the toilet, a litter box is configured to be placed in the toilet, a food bowl and a water bowl are configured to be placed in the dining area, a lower cage door is provided in front of the toilet, and an upper cage door is provided in front of the playing area.

2. The cat cage of claim 1, wherein a separator board is provided between the toilet and the dining area.

3. The cat cage of claim 1, wherein a right baffle is provided at a bottom portion of a right side of the toilet.

4. The cat cage of claim 1, wherein a lower baffle is provided at a bottom portion of a right side of the dining area.

5. The cat cage of claim 1, wherein an upper baffle is provided at a right side of the sleeping area.

6. The cat cage of claim 1, wherein a front protective net is provided at a front side of the cage body.

7. The cat cage of claim 1, wherein a right protective net is provided at a right side of the cage body.

8. The cat cage of claim 1, wherein an upper protective net is provided on a top side of the cage body.

9. The cat cage of claim 1, wherein the cage body is formed by wood material and meshes.

10. The cat cage of claim 1, wherein casters with brakes are provided at a bottom side of the cage body.
